(19) United States
(12) Patent Application Publication
(10) Pub. No.: US 2004/0174908 A1
(43) Pub. Date: Sep. 9, 2004

(54) Method for the splicing of digital signals before transmission, splicer and resulting signal

(76) Inventors: Eric Le Bars, Geveze (FR); Christophe Berthelot, Erce Pres Liffre (FR); Samuel Vermeulen, Rennes (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/733,813

(22) Filed: Dec. 12, 2003

(30) Foreign Application Priority Data
Dec. 13, 2002 (FR) 02 15847

(51) Int. Cl. H04J 3/02

(52) U.S. Cl. 370/516; 370/537

(57) ABSTRACT

A method is disclosed for splicing digital signals comprising packets of complete data and differential data at the transmission stage, especially MPEG-2 signals. The major reactions are those of erroneous reactions of the standardized decoder (T-STD) owing to the splicing. A splicing method is disclosed, comprising the following steps: receiving a first digital signal s1; receiving a second digital signal s2; receiving a splicing command Cc(T₀); transmitting the first signal s1 before the splicing indicated by the splicing command Cc(T₀), and transmitting the second signal s2 after the splicing indicated by the splicing command Cc(T₀); wherein the transmission of the second signal s2 starts with the I or P packets of complete data closest to the instant To indicated by the splicing command Cc(T₀) in such a way that the reproduction of the second signal s2 starts with the reproduction of the I or P packet of complete data.

### BACKGROUND OF THE INVENTION

1. Field of the Invention

The invention relates to a method for the splicing of digital signals comprising packets of complete data and differential data at the transmission stage. In particular, the splicing method of the invention is adapted to digital broadcast video signals such as MPEG-2/DVB signals for example.

In the world of television, the demand from viewers is causing the number of audiovisual program sources to increase as an ever-faster rate. The distributors of these programs are able to create new packages of programs which, in the context of cell phone networks such as the earth television network, can be customized according to the geographical zone of the broadcast. Thus, today, with the analog earth television mode of distribution, the channels are customizing their contents in order to broadcast regional and local information programs.

The passage of program broadcasting into digital (MPEG-2/DVB) mode is optimizing the use of radio frequencies by achieving an eightfold reduction in the bandwidth needed to broadcast a program. It is thus possible to broadcast eight times more programs and thus meet the demand from viewers for access to new programs and services.

This technological progress provided by digital compression is therefore of benefit to the broadcasting of new services. However, services already available in analog television, such as cutaways to local programs, need to be preserved.

Indeed, in the world of digital television, the number of peripheral services and more generally of primary signals is tending to increase ever more rapidly and broadcasting operators are able to create new program packages dedicated to their customers. The contents of these program packages are based on the re-utilization of existing services with the possibility of new local services.

The operation of generating a new digital multiplexing system from existing multiplexed digital inputs is called “re-multiplexing”.

A re-multiplexer is essentially a piece of equipment that receives a number of inputs signals and enables the operator to make a selection, from among these signals, of the service that he wishes to have injected into his own network, some of these signals being possibly local sources such as MPEG2 encoders, video servers, IP gateways etc.

As in the case of program re-multiplexing, the insertion of local services necessitates specific operations to process the programs. In addition to this common processing, additional processing is required to carry out the insertion of local services. The signal-processing function in which programs are inserted in an existing multiplexed signal is more generally called “splicing” and the device is called a “splicer”.

2. Description of the Prior Art

A first solution used to meet this requirement is based on a return to the natural (analog) domain, in which the programs to be inserted are decoded and re-coded. This solution is costly, unreliable and complex to implement because it requires many pieces of equipment. It requires processing with high computation capacity. To cope with this complexity, existing products integrate the twofold function of decoding and re-coding but their cost makes them poorly competitive in the large-scale RF television market.

The constraint of an economical solution prohibits a splicing method based on the natural (analog) domain. The solution therefore requires the processing of the splicing directly in the digital domain. The main difficulty of processing in the digital domain, MPEG-2 in the present case, lies in the fact that the pictures of a program are not transmitted in the order of display. Indeed, to obtain maximum compression, MPEG-2 defines groups of pictures (GOP) in which certain pictures are not entirely transmitted since, in general, in an audiovisual sequence, there is a large number of data that are redundant from one picture to another.

The major risks lie in the erroneous reactions of the standardized decoder (T-STD) owing to sudden splicing with a local service. For example, minor errors can arise as in a picture containing one or more mosaic patterns because of a video decoding error (especially when the decoder does not have the complete picture but only the differential pictures). Greater errors may consist in the freezing of the pictures because of the fact that the decoder is not supplied with data (since the pictures are not transmitted in the order of display). A major error lies in the display of a black picture induced by the fact that the decoder is malfunctioning.

The present invention overcomes these drawbacks by repositioning the instant of splicing on the complete picture closest to the program broadcast after splicing.

### SUMMARY OF THE INVENTION

The invention relates to a method for the splicing of digital signals comprising at least two types of data packets: packets of complete data and packets of differential data, said method comprising the following steps:

the reception of a first digital signal s1,

the reception of a second digital signal s2,

the reception of a splicing command,

the transmission of the first signal s1 before the splicing indicated by the splicing command, and

the transmission of the second signal s2 after the splicing indicated by the splicing command,

the transmission of the second signal s2 starting with the complete data packets closest to the instant indicated by the splicing command in such a way that the reproduction of the second signal s2 starts with the reproduction of the complete data packet.

Furthermore, the transmission of the first signal s1 ends, as the case may be, by the transmission of the second data packet received before the beginning of the transmission of the second signal s2 in such a way that the reproduction of the first signal s1 ends with the reproduction of a packet of complete data.

Another object of the method is a splicer implementing the splicing method and comprising:

a first input for the reception of the first signal s1,

a second input for the reception of the second signal s2,

an output for the transmission of the resulting signal formed by the first signal s1 before the splicing indicated by the splicing command and the second signal s2 after the splicing indicated by the splicing command.

In one variant of the invention, the splicer has a watermark reader connected to the first input.

The invention furthermore proposes a system for the production and broadcasting of signals, the system comprising at least:

an assembly for the production of a first and second signal s2, said production assembly comprising a watermark writing device receiving the first signal s1 and a splicing command and giving a first signal s1 watermarked by the splicing command, and

a transmission assembly comprising a splicer with watermark reader.

The invention also relates to a digital broadcasting signal comprising a first signal s1 followed by a second signal s2 starting with a packet of complete data obtained by this splicing method.

### BRIEF DESCRIPTION OF THE DRAWINGS

The features and advantages of the invention shall appear more clearly from the following description, given by way of an example, and from the figures relating thereto, of which:

FIG. 1, illustrates the splicing method applied to video programs,

FIGS. 2a and 2b, are schematic views of the choice of the starting point for the transmission of the second signal s2 relative to its reproduction, according to the invention, FIG. 2a illustrating the rear repositioning of the splicing point, and FIG. 2b illustrating the front repositioning of the splicing point,

FIGS. 3a and 3b, are schematic views of the implementation of the splicing method according to the invention, FIG. 3a proposing a schematic view of the first and second signals s1 and s2, and of the resulting signal transmitted during the implementation of the splicing method according to the invention, FIG. 3b proposing a schematic view of the reproduction of the signal resulting from the implementation of the splicing method,

FIGS. 4a and 4b, are schematic views of the implementation of the splicing method according to the invention, FIG. 4a proposing a schematic view of the first and second signals s1 and s2, which are audio and video signals, and of the resulting audio and video signal transmitted during the implementation of the splicing method according to the invention, FIG. 4b proposing a schematic view of the reproduction of the signal resulting from the implementation of the splicing method,

FIG. 5 is a schematic view of the clock of the first and second audio/video signals s1 and s2 and of the resultant audio/video signals during the implementation of the processing of the audio and video synchronization in the splicing method according to the invention,

FIG. 6 is a block diagram of the parts of the production and transmission assemblies used to control the watermark splicing of the first signal s1 according to the invention.

FIG. 1 illustrates the splicing principle. The splicer 210 receives a first signal s1, the second signal s2 and the splicing command C_{C}(T₀) at the instant T₀. The splicer 210 then composes the resulting signal sr as being equal to the first signal s1 until the instant T₀ and thereafter equal to the second signal s2.

The digital signal splicing method according to the invention therefore comprises the following steps:

the reception of the first digital signal s1,

the reception of the second digital signal s2,

the reception of a splicing command Cc(T),

the transmission of the first signal s1 before the splicing indicated by the splicing command (sr(t)=s1(t) for t<T), and

the transmission of the second signal s2 after the splicing indicated by the splicing command (sr(t)=s1(t) for t>T).

The splicing method according to the invention can be applied especially to digital signals comprising at least two types of data packets: packets of complete data (complete data packets) and packets of differential data (differential data packets). The transmission of the second signal s2 starts with the complete data packet closest to the instant indicated by the splicing command in such a way that the reproduction of the second signal s2 starts with the reproduction of this complete data packet.

The first and second signals s1 and s2 may comprise several types of complete data packets including at least one packet of introductory complete data and at least one packet of converted complete data. In one variant of the splicing method using this type of first signal and second signal s1 and s2, the transmission of the second signal s2 then starts with a packet of introductory complete data closest to the instant indicated by the splicing command.

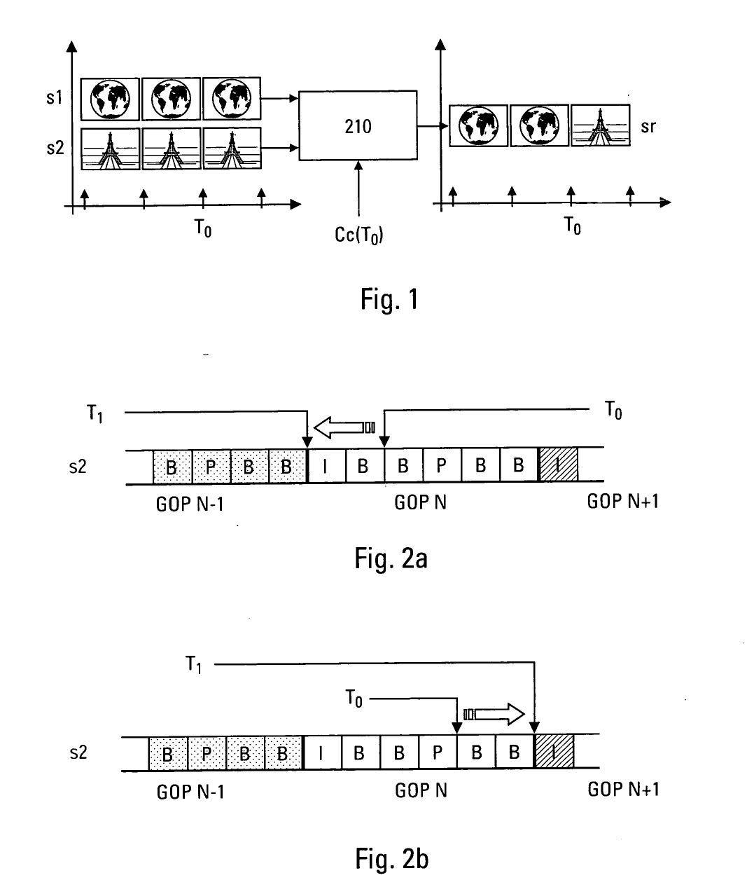

FIGS. 2a and 2b illustrate the splicing method with a transmission of the second signal s2 starting with a packet of introductory complete data closest to the instant indicated by the splicing command in such a way that the reproduction of the second signal s2 starts with the reproduction of this packet of introductory complete data. The signals of FIGS. 2a and 2b are MPEG-2 type digital video signals comprising groups of packets constituted by groups of pictures (GOP), the complete data packets constituted by the I and P pictures and the differential data packets constituted by the B pictures. The I pictures are constituted by introductory complete data packets and the P pictures are constituted by predicted complete data packets and several differential data packets.

The first and second signals s1 and s2 may comprise groups of packets comprising a single packet of introductory complete data with which it starts, the differential data packets enabling reproduction by using packets of future predicted complete data. Hence, the transmission of the packets is done in the group of packets in an order different from that of their reproduction in the group.

Since the second signal s2 must obligatorily start with a complete data packet, especially an introductory packet (an I picture in the present example), the repositioning of the splicing instant at T₁ is done on the picture I of the second reproduced signal s2 closest to the real splicing instant T₀.

In the case of FIG. 2a, the I picture of the second reproduced signal s2 closest to the real instant of splicing T₀ is reproduced from the instant T₁ before the instant T₀. The splicing method then comprises the rear repositioning of the splicing instant: the repositioned splicing instant is T₀. Thus, the transmission of the second signal s2 will start with this picture of I.

In the case of FIG. 2b, the I picture of the second reproduced signal s2 closest to the real splicing instant T₀ is reproduced from the instant T₁ after the instant T₀. The splicing method then comprises the front repositioning of the splicing instant: the repositioned splicing instant is T₀. Thus, the transmission of the second signal s2 will start with this I picture.

Through this repositioning of the splicing instant, the distribution of the data packets of the first and second signals s1 and s2 is not modified. This averts the use of the buffer memories necessary in the splicing together of the last group of data packets of the first signal s1 and of the last group of data packets of the second signal s2. To cope with the absence of modification of the distribution of the data packets, the splicing instant is adjusted relative to the real order of reproduction. This adaptation never exceeds the size of a half-group of data packets as illustrated in FIGS. 2a and 2b.

Thus, the splicing command C_{C}(T₀) is obtained with a lead of one group of data packets, i.e. a half second lead in the present example.

The resolution of the splicing according to the invention is therefore achieved to within one half-group of data packets. In the present example, with MPEG-2 signals, this is equivalent to a precision of ¼ second: this precision is acceptable for television broadcasts.

The splicing command C_{C}(T₀) at the instant To uses the domain of reproduction of the signals as a reference. In certain cases, the encoders may adopt a strategy of transmission of the pictures with a large lead on reproduction in making profitable use of the memories of the decoders. The splicing method according to the invention works in transmission, and the splicing command C_{C}(T₀) at the instant T₀ must be known so that this method can be implemented during the transmission of the first and second signals s1 and s2 and not at the time of reproduction. Experiments on MPEG-2 type signals have shown that this period never goes beyond 1 GOP (½ second). Thus, the step of reception of the splicing command C_{C}(T₀) at the instant T₀ is performed at least one GOP before the instant T₀.

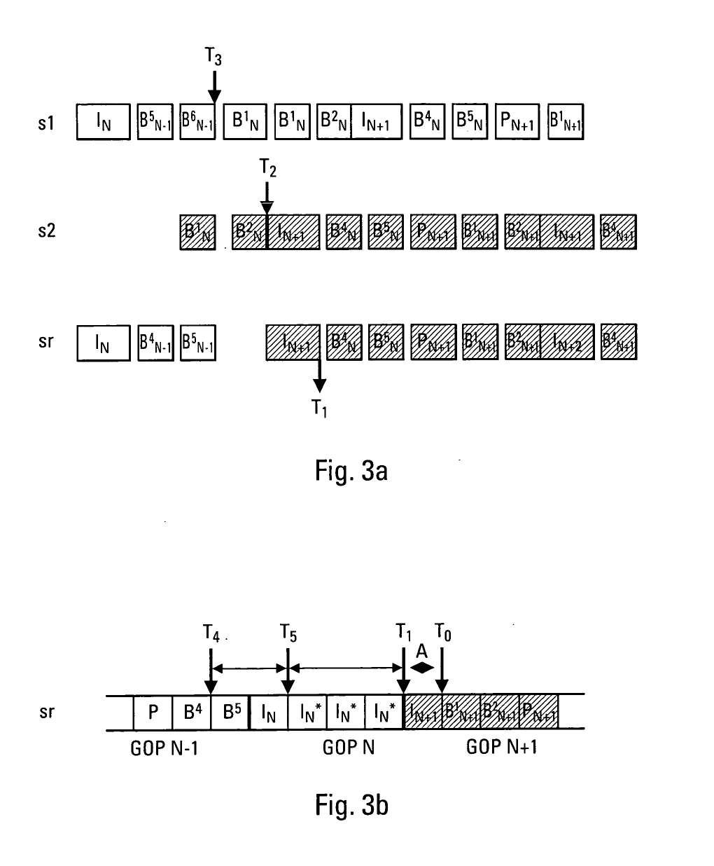

FIGS. 3a and 3b show the implementation of the splicing method according to the invention. The signals of this example are MPEG-2 type video signals. The streams of the first and second signals s1 and s2 are considered to be synchronized at reproduction.

FIG. 3b shows the reproduction of the signal resulting from the implementation of the splicing method according to the invention:

T₀ is the real splicing instant indicated by the splicing command C_{C}(T₀).

T₁ is the repositioned splicing instant in the determined domain of reproduction determined as indicated in the description of FIGS. 2 and 2b: it corresponds to the instant of the beginning of the reproduction of the complete data packet s2(I_{N+1}), especially of introductory data (I picture in the present example) closest to the second signal s2.

A=T₀−T₁ is the time interval of the repositioning the splicing in the reproduction field.

FIG. 3a shows the following: on the first line, the first signal s1 as received; on the second line, the second signal s2 as received; and on the third line, the signal resulting from the implementation of the splicing method according to the invention as transmitted. In this FIG. 3a:

T₂ is the instant of starting of the reception of the picture s2(I_{N+1}) reproduced at the repositioned splicing instant T₁ of the second signal s2. T₂ is therefore the repositioned splicing instant in the field of transmission. The transmission of the resultant signal sr thus comprises the transmission of the second signal s2 from this instant onwards T₂: sr(t)=s2(t) for t□T₂ in transmission mode.

The step of the transmission of the first signal s1 in splicing method according to the invention can be configured in such a way that it ends with the transmission of the last data packet received B, P or I before the start T₂ Of transmission of the second signal s2 in such a way that the reproduction of the first signal s1 ends with the reproduction of a complete data packet P or I before the start of reproduction of the second signal s2.

The transmission of the complete data packets I_{N} and P_{N+1} before the differential data packets respectively (B⁴_{N-1}, B⁵_{N-1}) and (B¹_{N+1}, B²_{N+1}) can be configured in such a way that the reproduction of these complete data packets I_{N} and P_{N+1} is done after the reproduction of these differential data packets (B⁴_{N-1}, B⁵_{N-1}) and (B¹_{N+1}, B²_{N+1}) as can be seen in the example of FIGS. 3a and 3b.

In this case, the configuration of the transmission of the first signal s1 is done in such a way that it ends with the transmission of the last data packet received (B, P or I data packet) before the start T₂ of the transmission of the second signal s2 in such a way that the reproduction of the first signal s1 ends with the reproduction of a P or I complete data packet before the start of reproduction of the second signal s2. This configuration can be done as follows:

The transmission of the first signal s1 ends with the transmission of the last differential data packet s1(B) received before the start T₂ of the transmission of the second signal s2 and preceding a complete data packet I, P.

The digital broadcasting signal sr resulting from the splicing according to the invention thus has a first signal s1 followed by a second signal s2 starting with a complete data packet, s2(I_{N+1}) for example, obtained by the splicing method described here above.

Thus, in the example of FIG. 3b, T₃ is the instant of the end of reception of the picture s1(B⁵_{N-1}) of the first signal s1 preceding a complete data packet (I or P type picture for example): s1(P_{N}) and the instant T₂ (T₃<T₂). The transmission of the resultant signal sr thus comprises the transmission of the first signal s1 up to this instant T₃: sr(t)=s1(t) for t□T₃ in transmission mode.

In FIG. 3b which shows the reproduction of the resultant signal sr of the implementation of the splicing method according to the invention:

T₄ is the instant of reproduction of the last data packet s1(B⁵_{N-1}) of the first signal s1 transmitted in the resulting signal sr. The reproduction of the last data packet s1(B⁶_{N-1}) of the first transmitted signal s1 precedes the reproduction of an I or P complete data packet of the first signal s1: s1(I_{N}) on the FIG. 3b.

T₅ is the instant of the end of reproduction of the last data packet s1(I_{N}) of the first signal s1. This packet will be duplicated I*_{N} at output by the decoder, especially in the case of MPEG-2 type signals, in the event of the absence of a new data packet to be reproduced. In the example of MPEG-2 type signals, the number of duplicated pictures will range between 0 and the number of B pictures between I or P pictures of the first signal s1 to which will be added the number of B pictures between I or P pictures of the second signal s2.

In the context of television program broadcasting, the number of duplicated pictures will range between 0 and 4 pictures. This number of pictures is seamless and corresponds to a 200 ms picture freeze. If the delay in the reproduction of the second signal s2 is greater than that of the first signal s1, the difference between the delay in reproduction of the first signal s1 and the delay in reproduction of the second signal s2 in terms of corresponding numbers of pictures must be added to the number of duplicated pictures.

To reduce the number of duplicated data packets, the reception of the pictures of the second signal is delayed. Thus, the first signal is transmitted for a longer period in the form of the resulting signal, reducing the number of duplicated data packets to an equivalent extent. This operation entails an increase in the bit rate of reception of the second signal. The transmission of the second signal s2 in the form of the resultant signal sr can then comprise either the reduction of the bit rate of transmission of the second signal s2, or the elimination of several differential data packets (B pictures for example) from the second signal s2 in order to return to a bit rate of transmission of the second signal s2 equivalent to that existing without the delay in reception.

In the case of MPEG-2 type signals, the B* pictures (not shown) of the second signal s2 referencing I and P pictures of the second signal s2 which have not been transmitted are replaced placed by video padding. They are not reproduced.

B=T₁−T₅ is the period of reproduction of absent data packets. This period is greater than or equal to 0 s. If this period is smaller than 0, the instant T₃ must be shifted to the end of reception of the B picture of the first signal s1 preceding an I or P picture preceding the instant that was first chosen.

C=T₅−T₄ is the incompressible period of reproduction of the last pictures of the first signal s1. This period is equal to 80 ms in terms of television program broadcasting.

During the splicing period, the data packets of the first signals s1 received after the instant T₃ are eliminated, i.e. they are not sent in the resulting signal sr. To obtain this elimination, the instant T₁ must be known. To this end, during the step of reception of the first signal s1 in the splicing method, the data packets of the first signal s1 can be entered in a buffer configured in such a way that the delay created at reception between the first and second signals s1 and s2 provides knowledge of T₁ to eliminate the data packets of the first signal s1 after T₃ (delayed by one GOP for example for MPEG-2 type signals).

The MPEG-2 has defined a decoder model used to simulate the rate of filling of the memories of the decoder. In one variant of the splicing method complying with this decoder model, the size of the data packet of the second signal is modified as a function of the filling of the memory of the decoder during and after the splicing to tend towards filling rates such as would have existed without the splicing. When the MPEG-2 decoders have more memory than that recommended by the standard, this modification in the size of the data packet of the second signal may be eliminated especially as it is a costly function.

The first signal s1 and the second signal s2 may also comprise audio frames. In particular, the digital signals s1 and S2 may be MPEG-encoded, comprising the groups of packets constituted by the groups of pictures (GOP), the complete data packets constituted by the I and P pictures and the differential data packets constituted by the B pictures, and audio frames.

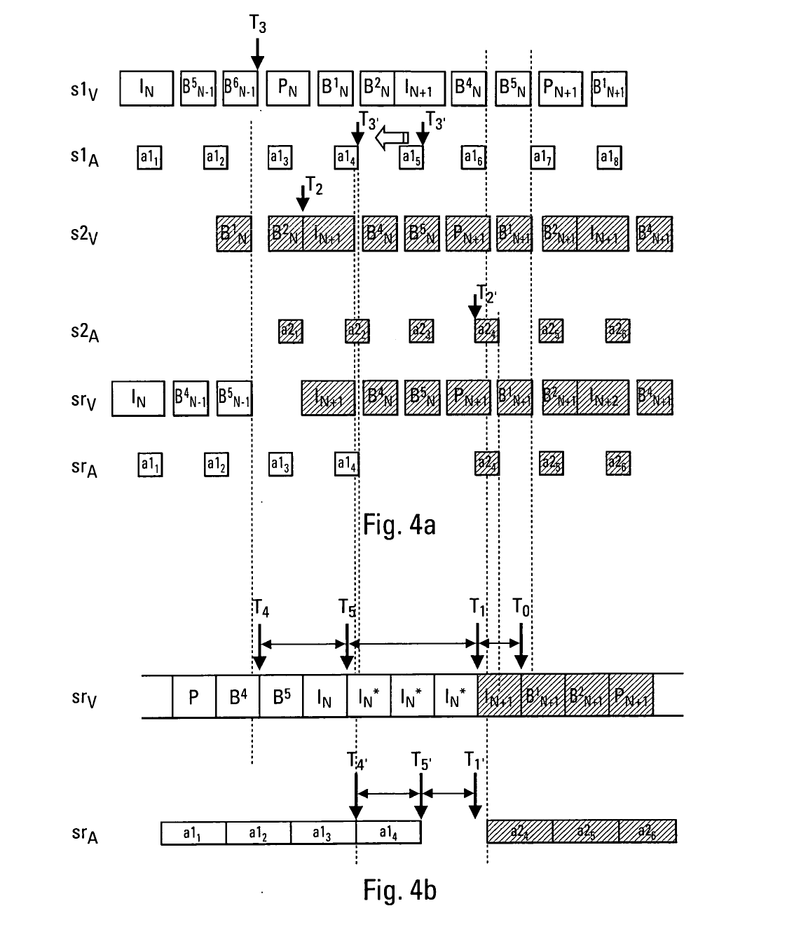

FIGS. 4a and 4b illustrate audio splicing in the case of MPEG-2 type audiovisual signals. The streams of the different signals are considered to be synchronized at reproduction.

In FIG. 4b which shows the video reproduction of the first line and the audio reproduction on the second line of the signal resulting from the implementation of the splicing method according to the invention:

T₀ is the real splicing instant indicated by the splicing command C_{C}(T₀).

T₁ is the repositioned splicing instant in the determined field of reproduction as indicated in the description of FIGS. 2 and 2b: it corresponds to the instant of the start of reproduction of the packet of complete data s2(I_{N+1}), especially introductory data (I picture for example) closest to the second signal s2.

FIG. 4a shows the following: on the first and second lines respectively, the first signal s1 as received, comprising respectively its video part s1ᵥ and its audio part s1_{A}, on the third and fourth lines the second signal s2 as received, comprising respectively its video part s2ᵥ and audio part s2_{A}, and on the fifth and sixth lines, the signal sr resulting from the implementation of the splicing method according to the invention as transmitted, comprising respectively its video part srᵥ and its audio part sr_{A}:

The step of transmitting the second signal s2 of the splicing method according to the invention starts with the audio frame s2_{A}(a2₄) configured to be reproduced with a picture constituted by the introductory complete data packet s2ᵥ(I_{N+1}) with which the transmission of the second signal s2 is started.

T′₂ is thus the instant of the starting of reception of the audio frame s2_{A}(a2₄) of the second signal s2 reproduced after the instant T₁. The transmission of the resultant signal sr thus comprises the transmission of audio frames of the second signal s2 from this instant T′₂: sr_{A}(t)=s2_{A}(t) for t□T′₂ in transmission mode.

The step of transmitting the first signal s1 in the splicing method according to the invention ends with:

the transmission of the last audio frame s1_{A}(a2₅) starting before the instant of the start of the transmission of the second signal s2 if the time interval between the start of transmission of this audio frame and the start of transmission of the second signal s2 is greater than or equal to the duration of an audio frame,

or else the transmission of the second last audio frame s1_{A}(a1₄) starting before the instant of the start of transmission of the second signal s2.

T′₃ is thus, in the example of FIG. 4b, the instant of the end of reception of the frame s1_{A}(a1₄) of the first signal s1 preceding T′₂. The transmission of the resultant signal sr thus comprises the transmission of the audio frames from the first signal s1 up to this instant T′₃: srₐ(t)=s1ₐ(t) for t□T′₃ in transmission mode.

In FIG. 4b which shows the video and audio reproduction of the signal resulting from the implementation of the splicing method according to the invention:

T₄ is the instant of the start of reproduction of the last data packet s1 (B⁵_{N-1}) of the first signal s1 sent in the resulting signal sr. The reproduction of the last data packet s1(B⁵_{N-1}) of the first signal s1 transmitted precedes the reproduction of an I or P complete data packet of the first signal s1:s1(I_{N}) in FIG. 4b.

T′₄ is the instant of the start of reproduction of the last audio frame s1_{A}(a1₄) of the first signal s1 sent in the resulting signal sr.

T₅ is the instant of the end of reproduction of the last data packet s1(I_{N}) of the first signal s1. This packet will be duplicated I*_{N} at output by the decoder, especially in the case of MPEG-2 type signals, when there is no new data packet to be reproduced. In the example of MPEG-2 type signals, the number of duplicated pictures will range from 0 to the number of B pictures between I or P of the first signal s1 to which there will be added the number of B pictures between I or P of second signal s2.

T′₅ is the instant of the end of reproduction of the last audio frame s1_{A}(a1₅) of the first signal s1 transmitted in the resulting signal sr. During its audio reproduction, the audio part of the resulting signal sr could therefore contain a reproduction gap. This reproduction gap will not exceed one audio frame at the time of the splicing, and this is imperceptible in the context of the broadcasting of the television program.

B′=T₁−T′₅ is the period of the audio reproduction gap. This period is greater than or equal to 0 s. If this period is smaller than 0, it is necessary to shift T3′ with respect to the end of transmission of the previous audio frame s1_{A}(a1₄) of the first signal s1. This was done in FIG. 4a as an example.

C′=T′₅−T′₄ is the incompressible period of reproduction of the last audio frame s1_{A}(a1₅) of the first signal s1.

The first and second signals s1 and S2 to be spliced are not necessarily synchronized. To ensure the continuity of the rate of reproduction in splicing, it is necessary to adapt the rate of reproduction of the data of the second signal s2 to the rate of reproduction of the first signal s1.

To ensure maximum seamless quality of splicing at the decoder, it is useful to ensure the continuity of the digital clock of the resulting signal sr. The clock of the signals is used by the decoders to set up an automatic control loop between their own internal clocks and the clock of the signal encoder of the signal. The transmission of the drift of the active signal-encoding clock to the decoder is therefore interesting. The term “active signal” is understood to mean that signal, among the first and second signals s1 or s2 that is transmitted in the resulting signal sr.

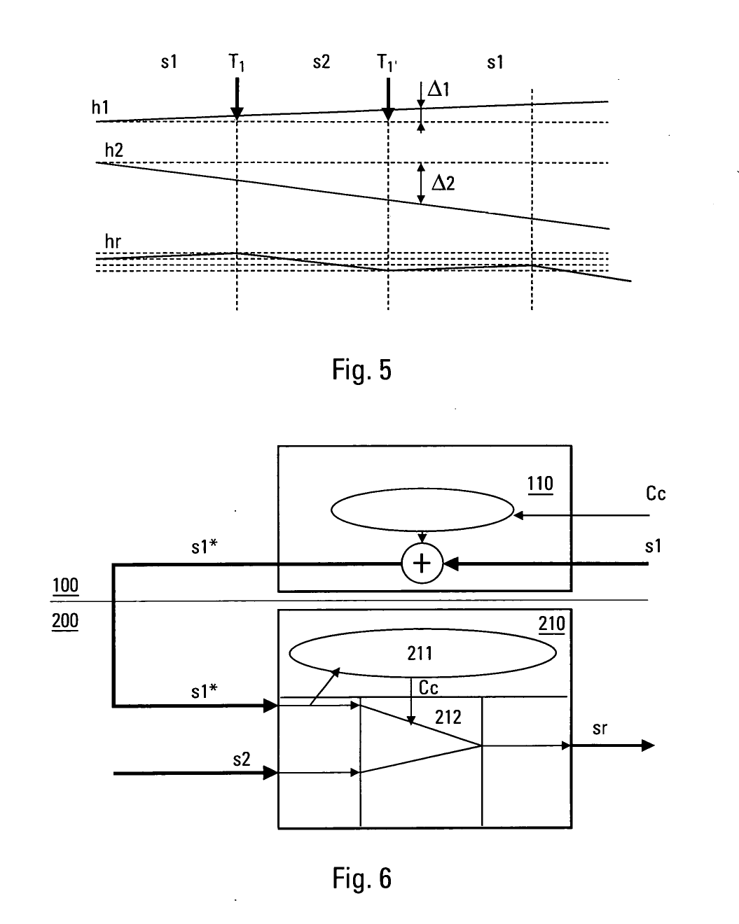

FIG. 5 illustrates a solution to the processing of the audio and video synchronization of the resultant signal sr.

T1 is the instant of splicing of the first signal s1 to the second signal s2. The value of the clock h2 of the second signal s2 is synchronized with the clock h1 of the first signal s1. During the transmission of the second signal s2 in the resulting signal sr, the drift Δ2 of the clock h2 of the second signal s2 is transmitted to the decoder.

T′1 is the instant of splicing of the second signal s2 with the first signal s1. The value of the clock h1 of the first signal s1 is synchronized with the clock h2 of the second signal s2. During the transmission of the first signal s1 in the resultant signal sr, the drift Δ1 of the clock h1 of the first signal s1 is transmitted to the decoder.

The synchronization of the clocks h1, h2 and hr consists of the addition of the difference between the clock values of the first and second signals s1 and s2 at T1. This value is thereafter constantly added to the clock values of the second signal s2 and to the values of the instants of reproduction of the pictures and of the audio frames of the second signal s2 when it is being transmitted in the resulting signal sr.

At present, there are different methods for transmitting the splicing command from a control center to the equipment that has to carry out the splicing. The splicing command C_{C}(T₀) may therefore be given in different ways, for example by means of a man/machine interface connected to the splicer 210.

The splicing is of the kind described here above, implemented by a splicer 210 comprising:

a first input for the reception of the first signal s1,

a second input for the reception of the second signal s2,

an output for the transmission of the resulting signal sr formed by the first signal s1 before the splicing indicated by the splicing command Cc and the second signal s2 after the splicing indicated by the splicing command Cc.

FIG. 6 proposes the watermarking of the splicing command Cc(T₀) in the first signal s1. For example, the transmission of this splicing command C_{C}(T₀) can be done by embedding the splicing command C_{C}(T₀) directly in the video slᵥ with a video watermarking technique (especially as described in the patent EP 1173980 with regard to video watermarking and the patent application FR 0114857 with regard to watermarking and the reading of commands in programs, these commands being designed for broadcasting/transmission assemblies). This method enables the transmission of information generally related to copyright information. The splicing command C_{C}(T₀) thus embedded can be analyzed and extracted from the first watermarked signal s1* by a watermark reader device 211 of the splicer 210 to activate the splicing proper 212 from the first signal s1 to the second signal s2.

As can be seen in FIG. 6, the signal production and broadcasting system comprises an assembly 100 for the production of the first signal s1, and a transmission assembly 200 comprising said splicer 210. The production assembly 100 has a watermark writing device 110 receiving the first signal s1 and a splicing command C_{C}(T₀) and giving a first watermarked signal s1* through the splicing command. The splicer 210 in this alternative embodiment comprises a watermark reader 211 connected to its first input controlling the splicing 212.

The main advantage of such a method is that it ensures the presence of the splicing command C_{C}(T₀) even after advanced processing operations (such as a re-multiplexing, transcoding, format conversion etc) on the program.

This splicing approach applied to audiovisual programs in the digital field enables an economical implementation to meet the requirements of the large-scale distribution of products fulfilling this function. This approach is sufficient to resolve the questions related to the cutaway operations for regional or local programs because the imperfections of the splicing (duplicated pictures) linked to the economic constraints of the function are hardly perceptible to the eye and the ear.

This type of splicing also enables the splicing of a first signal comprising a program with a second signal comprising either advertisements or jingles etc.

What is claimed is:

1. A method of splicing digital signals comprising at least two types of data packets: I and P packets of complete data and B packets of differential data, said method comprising the following steps:
receiving a first digital signal s1;
receiving a second digital signal s2;
receiving a splicing command Cc(T₀);
transmitting the first signal s1 before the splicing indicated by the splicing command Cc(T₀); and
transmitting the second signal s2 after the splicing indicated by the splicing command Cc(T₀),
wherein transmission of the second signal s2 starts with the I or P packets of complete data closest to the instant To indicated by the splicing command Cc(T₀) in such a way that the reproduction of the second signal s2 starts with the reproduction of the I or P packet of complete data.

2. The splicing method according to claim 1, wherein transmission of the first signal s1 ends with transmission of the last I, P or B packet of data received before the start of transmission of the second signal s2 in such a way that the reproduction of the first signal s1 ends with the reproduction of an I or P packet of complete data before the start of reproduction of the second signal s2.

3. The splicing method according to claim 1, wherein transmission of the I or P complete data packets before the B differential data packets is configured in such a way that the reproduction of these I or P packets of complete data is performed after the reproduction of the B packets of differential data.

4. The splicing method according to claim 2, wherein transmission of the I or P complete data packets before the B differential data packets is configured in such a way that the reproduction of these I or P packets of complete data is performed after the reproduction of the B packets of differential data.

5. The splicing method according to claim 4, wherein transmission of the first signal s1 ends with transmission of the last B packet of differential data received before the start of transmission of the second signal s2 and preceding an I or P packet of complete data.

6. The splicing method according to claim 1, wherein the first and second signals s1 and s2 comprise several types of complete data packets, including at least one I packet of introductory complete data and at least one P packet of predicted complete data, and several B packets of differential data are assembled in a group of packets GOP comprising only one I packet of complete introductory data with which the GOP starts, the group of packets enabling the P packets of predicted complete data and the B packets of differential data to be transmitted in an order different from that of the reproduction of the P and B packets.

7. The splicing method according to claim 6, wherein transmission of the second signal s2 starts with the I packet of introductory complete data closest to the instant To indicated by the splicing command Cc(T₀).

8. The splicing method according to claim 1, wherein the first signal s1 and the second signal s2 are video signals.

9. The splicing method according to claim 1, wherein the first signal s1 and the second signal s2 further comprise audio frames.

10. The splicing method according to claim 8, wherein the first signal s1 and the second signal s2 further comprise audio frames.

11. The splicing method according to claim 10, wherein transmission of the second signal s2 starts with the audio frame configured to be reproduced with a picture constituted by the I packet of introductory complete data with which transmission of the second signal s2 is started.

12. The splicing method according to claim 11, wherein transmission of the first signal s1 ends with:
the last audio frame starting before the instant of the start of transmission of the second signal s2 if the time interval between the start of transmission of the audio frame and the start of transmission of the second signal s2 is greater than or equal to the duration of an audio frame,
or, if not, the second last audio frame starting before the instant of the start of transmission of the second signal s2.

13. The splicing method according to claim 9, comprising:
during transmission of the first signal s1, transmission of the drift Al of the clock h1 of the first signal s1,
during transmission of the second signal s2, transmission of the drift Δ2 of the clock h2 of the second signal s2.

14. The splicing method according to claim 12, comprising:
during transmission of the first signal s1, transmission of the drift Δ1 of the clock h1 of the first signal s1,
during transmission of the second signal s2, transmission of the drift Δ2 of the clock h2 of the second signal s2.

15. The splicing method according to claim 1, wherein the digital signals are MPEG-encoded, comprising groups of packets constituted by groups of pictures (GOP), the packets of complete data constituted by the I and P pictures, the packets of differential data constituted by the B pictures, and audio frames.

16. The splicing method according to claim 1, comprising watermarking of the splicing command Cc(T₀) in the first signal s1, wherein reception of the splicing command comprises reading the splicing command Cc(T₀) watermarked in the first signal s1*.

17. A splicer implementing a splicing method according to claim 1, comprising:
a first input adapted to receive a first signal s1,
a second input adapted to receive a second signal s2,
an output adapted to transmit a resulting signal formed by the first signal s1 before the splicing indicated by the splicing command Cc(T₀) and the second signal s2 after the splicing indicated by the splicing command Cc(T₀).

18. A splicer according to claim 17, comprising a watermark reader connected to the first input.

19. A system for the production and broadcasting of signals, comprising at least one assembly for the production of a first signal s1, a transmission assembly comprising a splicer according to claim 20, wherein the production assembly comprises a watermark writing device receiving the first signal s1, a splicing command Cc(T₀) and giving a first signal s1* watermarked by the splicing command.

20. A digital broadcasting signal comprising a first signal s1 followed by a second signal s2 starting with a packet of complete data obtained by a splicing method according to claim 1.
